(19) United States
(12) Patent Application Publication
(10) Pub. No.: US 2026/0002487 A1
(43) Pub. Date: Jan. 1, 2026

(54) SYSTEMS AND METHODS FOR ELECTRONICALLY CONTROLLING HIGH PRESSURE FUEL DELIVERY IN ENGINES

(71) Applicant: Enginuity Power Systems, Inc., Alexandria, VA (US)

(72) Inventors: Philip Zoldak, Plymouth, MI (US); Andrew Harman, Lapeer, MI (US); Maysam Molana, Troy, MI (US); Philipp Schimmels, Royal Oak, MI (US)

(73) Assignee: Enginuity Power Systems, Inc., Alexandria, VA (US)

(21) Appl. No.: 19/253,790

(22) Filed: Jun. 28, 2025

Related U.S. Application Data
(60) Provisional application No. 63/666,195, filed on Jun. 30, 2024.

(51) Int. Cl. F02D 41/30; F02D 41/40

(52) U.S. Cl. CPC F02D 41/3082; F02D 41/401

(57) ABSTRACT

An electronic control unit controls the injection of highly pressurized fuel into a combustion chamber while also controlling the pressure of such injections.

### RELATED APPLICATIONS

This application claims priority to U. S. Provisional Application 63/666,195 (the “'195 Application”). This Application is also related to Ser. No. 18/493,302 (the “'302 Application”), U.S. patent application Ser. No. 17/696,834 (the “'834 Application), U.S. patent application Ser. No. 17/151,253 (the “'253 Application”), PCT Application No. PCT/US2023/24939 (“'939 Application), co-pending U.S. Provisional Application ______ (sometimes referred to as the “high fuel pressure application”), co-pending U.S. Provisional Application ______ (sometimes referred to as the prechamber application) and co-pending U.S. Provisional Application ______ (sometimes referred to as the heated heavy fuel application). This application incorporates by reference in their entireties the disclosures of the '195, '302, '834, '253, '939 and the three co-pending Applications (collectively “Related Applications”) as if such Related Applications were set forth in full herein.

### GOVERNMENT RIGHTS

The inventive disclosures herein were made with U.S. government support under Contract Number W15P7T-19-D-0157 awarded by the United States Department of Defense. The U.S. government has certain rights in the inventive disclosures.

### TECHNICAL FIELD

This disclosure relates to the monitoring and control of small engines (e.g., <1.5 L/cylinder), such as inwardly opposed piston engines (OPEs), conventional in-line and Vee-configuration engines that can operate under compression ignition using heavy fuels such as diesel, biodiesel or Jet Propulsion (JP) 8 fuel, for example, at high fuel pressures (e.g., greater than 50 bar).

### INTRODUCTION

This section introduces aspects that may help facilitate a better understanding of the disclosure. Accordingly, the statements of this section are to be read in this light and are not to be understood as admissions about what is, or what is not, prior art.

Conventional fuel systems typically employ mechanical pumps along with standard lines and fittings to pressurize and deliver fuel to a pressure actuated, mechanical injector that includes a spring into a combustion chamber at lower pressures (e.g., below 250 bar). Such systems often suffer from inefficiencies in controlling the delivery of fuel, regulating fuel pressures, fuel atomization, excessive injection duration, leading to incomplete combustion, lower efficiency and higher emissions. Additionally, these systems do not have the ability to compensate effectively during abnormal environmental conditions such as cold temperatures (down to −50 F), high temperatures (up to 125 F), variations in altitude (sea level up to 4000 ft). Often, conventional mechanical fuel systems employed in these conditions are unable to adapt to the variations in altitude and temperature which results in power output degradations and/or lower fuel efficiencies.

Accordingly, it is desirable to provide inventive solutions that allow for the monitoring and control of engines that operate in such abnormal environmental conditions, including high altitudes, using increased fuel pressures to realize compression-ignition (CI) combustion that is clean and efficient across speed and load ranges for a range of temperatures and altitudes.

### SUMMARY

The inventors describe various exemplary, inventive systems and related methods for monitoring and controlling the pressures of an engine and its fuel to high levels (e.g., 50 bar to 1000 bar), such as an inwardly OPE and the engines set forth in the Related Applications, for example.

As described in more detail herein, by incorporating an inventive, advanced electronic control unit (ECU), and precise sensors to monitor fuel tank levels, engine coolant temperatures, oil pressure, and fuel injection rail pressures, synchronized accurately with engines by means of crank positions (collectively “inventive system”) the inventive system helps ensure optimal fuel delivery at substantially all engine operating conditions.

The inventive system may further include a high-pressure fuel rail, pressure control sensor and pressure control valve as described in co-pending U.S. provisional application ______ (“high fuel pressure application”) for example to further control and stabilize the fuel pressure upstream of an injector to promote optimal fuel atomization and efficient combustion and to reduce wall-wetting and particulate emissions. Additionally, the inclusion of a fast acting pressure relief valve (e.g., the valve described in co-pending U.S. provisional application ______ (high pressure application) may help to closely control the fuel pressure at a location that is upstream of the injector during both steady and transient engine operation.

In more detail, one exemplary electronic control unit (ECU) for monitoring and controlling at least fuel pressures of an engine where, the ECU may be configured to: generate a desired pressure control setpoint (PCR.sp) based on a speed of the engine and a torque setpoint (TQ.sp); compare the generated, desired pressure control setpoint to an actual pressure (PCR) measured by one or more pressure sensors; and adjust a pressure being generated by a fuel pump by sending electronic control signals to a fuel pump, solenoid driver.

In an embodiment the engine may comprise an inwardly opposed piston engine for example, and wherein the engine is configured to operate using both gaseous or liquid fuel. Further, the fuel may comprise one of a diesel, biodiesel, JP-8 or F-24 (NATO equivalent) or Fisher-Tropsch fuels to name just some examples of the fuels that may be used.

In one embodiment, the ECU may comprise an electronic Proportional Integral Derivative (PID) Controller.

In yet another embodiment an exemplary ECU may comprise (i) one or more pressure sensors, one or more fuel tank level sensors, one or more tank temperature sensors, one or more crank position sensors, wherein the ECU is further configured to ensure control and optimal performance of an engine and (ii) one or more input/outputs (I/O) and corresponding communication lines for exchanging electronic signals between the ECU and the engine.

Further, such an exemplary ECU may comprise at least one electronic memory for storing one or more instructions for completing and executing features and functions described herein, such as storing (i) a calibration look-up table that includes setpoint data and engine speed, (ii) data used to generate control and command signals to control (a) a quantity of fuel total to be injected into the engine, (b) fuel pressures (PCR). (c) injection times and duration for SOI main, pilot, and post injections and a (d) Duty STROKE MODEL process. Further, the exemplary ECU may further comprise retrieving and executing instructions for generating timing and pulse width command and control signals for a fuel injector based on an engine speed and RPM.

Still further, the exemplary ECU may be further configured to receive signals representing a temperature of the engine; and select a time period during which one or more glow plugs are turned on to heat the combustion chamber or fuel of the engine.

As noted above the ECU may comprise an electronic PID controller. More particularly the PID controller may be configured to: receive a value representing a comparison of a pressure control setpoint and actual pressure; and output one or more electronic signals to fuel pump solenoid driver to control a pressure generated by a fuel pump.

In addition to the ECUs and PID controllers the disclosure also provides methods for electronically controlling an engine. One such method comprises: i) receiving Inputs “N” and pedal position input data from a throttle pedal or generator controller at an ECU; ii) generating a torque setpoint from the Inputs N and pedal position input data; iii) generating a fuel mass total and start of injection (SOI) timing signals based on at least the generated torque setpoint. In such an exemplary method the inputs “N” comprise engine speed or fuel pressure, for example.

In such an exemplary method the generation of the fuel mass total may further comprise generating the fuel mass total based on the torque setpoint and an Inlet fuel pressure (P1), an outlet fuel pressure (P2) and a fuel mass (M). Further, such a method may yet further comprise generating a fuel injection duty cycle by inputting the fuel mass total into a Duty STROKE MODEL process that is stored as electronic instructions in an electronic memory of an engine. In an embodiment, the method further comprises controlling the timing and time duration of fuel injection per cycle by one or more fuel injectors using the generated fuel injection duty cycle and two variable values, where one of the two variable values comprises a value representing a camshaft position and the second one of the two variable values comprises an End Power Trim value. In such an embodiment, such a method further comprises adjusting an injection timing based on the two variable values.

In still another embodiment, the exemplary method further comprises generating a desired pressure control setpoint based on a speed of the engine and the torque setpoint and comparing the generated, desired pressure control setpoint to an actual pressure measured by one or more pressure sensors. In such an embodiment, the method may further comprise adjusting the pressure being generated by a fuel pump by sending electronic control signals to a fuel pump, solenoid driver.

The above is only one of the methods disclosed herein. Another exemplary method comprises a method for generating and implementing fuel injection timing and time periods of an engine comprising: i) generating a sequence of electronic signals representing “start” and “end” crank angles for an injection cycle; ii) sending the generated signals to an electronic injection, solenoid driver configured to output a set of control signals; iii) sending the output control signals to one or more fuel injectors to control the injection time period of fuel by the one or more fuel injectors into a combustion chamber of the engine.

In such an exemplary method the injection time period may comprise the time associated with a start of the injection of fuel until a time that the injection of fuel stops, where the fuel may comprise a heavy fuel, for example.

Yet another method is directed at cold starting an engine. Such a method may comprise receiving signals at an ECU representing a temperature of the engine; and selecting one or more time periods, by the ECU, during which one or more glow plugs are turned on by the ECU to heat the combustion chamber or fuel of the engine, among other steps.

The inventive systems and corresponding methods described above are just some of the inventive systems and methods that will be apparent from the disclosure herein.

The inventive ECU systems and related methods described herein provide a comprehensive control hardware system and strategy that improves engine performance and fuel efficiency while addressing environmental concerns by significantly lowering harmful emissions.

### BRIEF DESCRIPTION OF THE DRAWINGS

The present invention is illustrated by way of example and is not limited by the accompanying figures in which like reference numerals indicate similar elements and in which:

FIG. 1 depicts an exemplary architecture for monitoring and controlling the fuel pressure of an engine, such as an OPE, at various locations or points in the system, according to one embodiment of the present disclosure.

FIG. 2 represents an exemplary fuel system control methodology according to one embodiment of the present disclosure.

FIG. 3 depicts a graph of signals representing the operation of intake valve and fuel pressure with respect to an engine's crank angle (CA) according to experiments conducted by the inventors.

FIG. 4 depicts an exemplary cold start control methodology according to one embodiment of the present disclosure.

Specific embodiments of the present invention are disclosed below with reference to various figures and sketches. Both the description and the illustrations have been drafted with the intent to enhance understanding. For example, the dimensions of some of the elements in the figures may be exaggerated relative to other elements, and well-known elements that are beneficial or even necessary to a commercially successful implementation may not be depicted so that a less obstructed and a clearer presentation of embodiments may be achieved.

Simplicity and clarity in both illustration and description are sought to effectively enable a person of skill in the art to make, use, and best practice the present invention in view of what is already known in the art. One skilled in the art will appreciate that various modifications and changes may be made to the specific embodiments described herein without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EXEMPLARY EMBODIMENTS

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

As used herein and in the appended claims, the term “comprises,” “comprising,” or variations thereof are intended to refer to a non-exclusive inclusion, such that a process, method, article of manufacture, or apparatus (e.g., an OPE) that comprises a list of elements does not include only those elements in the list, but may include other elements not expressly listed or inherent to such process, method, article of manufacture, or apparatus.

The terms “a” or “an”, as used herein, are defined as one, or more than one. The term “plurality”, as used herein, is defined as two, or more than two. The term “another”, as used herein, is defined as at least a second or more.

Unless otherwise indicated herein, the use of relational terms, if any, such as “first” and “second”, “top” and “bottom”, “back” and “front”, and “left” and “right” and the like are used solely to distinguish one view, entity or action from another view, entity or action without necessarily requiring or implying any actual such relationship, order or importance between such views, entities or actions.

The terms “including” and/or “having”, as used herein, are defined as comprising (i.e., open language).

As used herein “x-axis” or “first axis”, “y-axis” or “second axis” and “z-axis” or “third axis” mean three different geometric directions and planes. Typically, the x-axis is used to indicate motion in a horizontal direction/plane, the y-axis is used to indicate motion in the vertical direction/plane and the z-axis is used to indicate motion in an axis that is perpendicular to both the x and y axes. However, depending on the orientation and supporting structure of an OPE, the origin of the three axes may be interchangeable.

As used herein the phrases “adapted to”, “operable to” and “configured to” mean “functions to” unless the context or knowledge of one skilled in the art indicates otherwise.

To the extent any dimension, weight, size, percentages, or operating parameters are described herein or shown in the figures (collectively “parameters”), it should be understood that such parameters are non-limiting and merely exemplary to allow those skilled in the art to understand the inventive embodiments described herein.

Similar reference numbers may denote similar components and/or features throughout the attached drawings.

As used herein, the phrase “electronic memory” (sometimes referred to as “memory” herein) means a non-transitory, electronic storage medium (e.g., volatile or non-volatile memory device). Examples of non-transitory, electronic storage media include, but are not limited to: a random access memory (RAM); a programmable read only memory (PROM); an erasable programmable read only memory (EPROM); a FLASH-EPROM; a magnetic computer readable medium (e.g., a floppy disk, hard disk, magnetic tape, any other magnetic medium); an optical computer readable medium (e.g., a compact disc read only memory (CD-ROM); a digital versatile disc (DVD); a Blu-Ray disc (BD), the like, or combinations thereof), or any other non-transitory medium from which an electronic processor can retrieve stored instructions that when executed cause an apparatus to perform one or more functions, features or steps in a method or process.

As used herein the phrase “electronic processor” means one of: electronic circuitry, at least one electronic processing core, one or more microprocessors with accompanying digital signal processor(s), one or more electronic processor(s) without an accompanying digital signal processor, one or more coprocessors, one or more multi-core processors, one or more electronic controllers, electronic processing circuitry, one or more computers, various other electronic processing elements including integrated circuits (for example, an application specific integrated circuit (ASIC), a field programmable gate array (FPGA), and/or the like), or some combination thereof. Accordingly, although illustrated in the figures as a single processor, in some example embodiments the processor may comprise a plurality of electronic processors or processing cores which when combined with at least one electronic memory that stores instructions may be executed by the electronic processor to cause an electronic control unit (ECU) to complete the functions and features disclosed herein. As noted elsewhere herein an ECU may comprise one or more electronic processors that cause the ECU to execute instructions from its electronic memory to complete inventive features and functions disclosed herein.

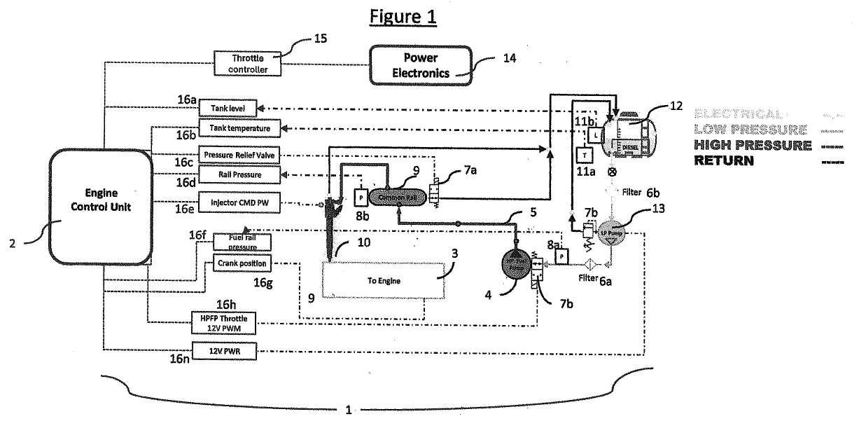

Referring to FIG. 1 there is depicted an exemplary architecture 1 for monitoring and controlling the pressure of an engine 3, such as those disclosed in the Related Applications, using an inventive ECU 2. In an embodiment, the inventive architecture 1 uses a combination of setpoints, models, and feedback loops to ensure precise control over fuel injection and pressure, aiming for optimal engine performance.

For purposes of explanation only, the engine 3 may be an OPE. The engine 3 may be configured to operate using both gaseous and/or liquid fuel (e.g., diesel, biodiesel, JP-8 or F-24 (NATO equivalent) or Fisher-Tropsch fuels) and using one or more combustion modes, such as controlled compression ignition or diffusion flame combustion, partially-premixed combustion compression ignition (PPCI) or gasoline direct-injection compression-ignition (GCI) or heated gasoline compression-ignition (HGCI), or conventional spark ignition, or prechamber spark-ignition both passive and active and or heated fuel spark ignition, for example.

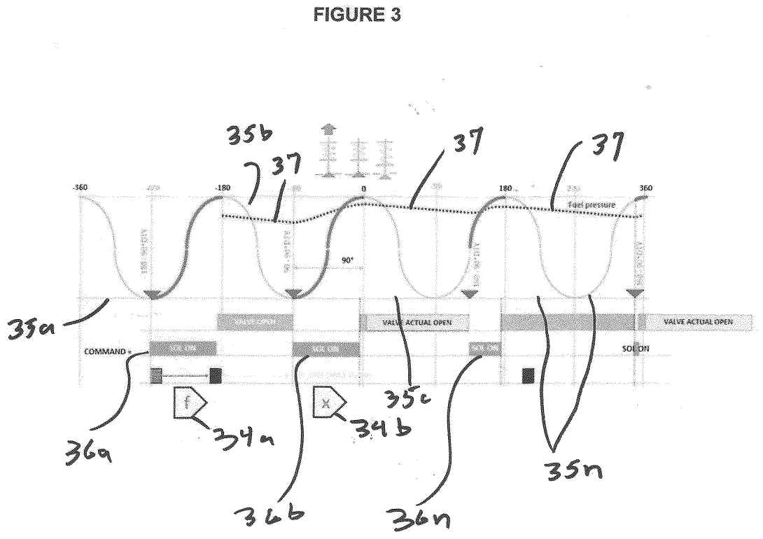

When the engine 3 comprises an inwardly opposed piston engine it should be understood that the inwardly facing pistons (not shown) of the engine 3 may have predetermined lengths and predetermined diameters. In one embodiment, the stroke length of each of the opposed pistons may be twice the amount of a conventional engine, for example, it being understood that the piston lengths may be geometrically determined in accordance with the piston stroke length and the lengths of apertures formed in a wall of the cylinders through which flow exhaust gases and air for combustion (e.g., see element 5a in FIG. 3C of the '253 Application). Thus, the total difference between the spacing of the pistons at closest approach to each other (i.e., at “top dead center”) and the maximum spacing of the pistons during the engine cycle (i.e., at “bottom dead center”) may also be twice the amount of a conventional engine, for example.

In addition to the ECU 2, the exemplary architecture 1 may include an electronically controlled fuel pump 4 (e.g., pulley-driven fuel pump or an intake/exhaust cam driven pump), one or more a high pressure fuel lines 5, one or more low pressure fuel lines 6, one or more pressure sensors 8a, 8b one or more pressure relief valves 7a,7b one or more fuel rails 9 (e.g., the fuel rails described in co-pending U.S. Provisional Application ______ (i.e., the high fuel pressure application), and one or more fuel injectors 10 (e.g., the injectors described in co-pending U.S. Provisional Application ______ (i.e., the high fuel pressure application), one or more fuel tank sensors 11a, 11b, a fuel tank 12, a low pressure fuel pump 13, a power electronics sub-assembly 14, a throttle controller 15 and one or more input/outputs (I/O) and corresponding communication lines 16a to 16n for exchanging electronic signals between the ECU 2 and a respective element of the architecture 1. Though shown as separate elements it should be understood that elements 1 to 12, 14, 15 and 16a to 16n may be considered part of the overall fuel system for an engine 3. For a detailed description of the features and operation of each of the elements in FIG. 1 (other than the ECU 2) the reader is referred to the three co-pending U.S. patent applications mentioned above.

In embodiments, the ECU 2 may comprise an electronic processor that is configured or adapted to monitor and control a plurality of elements of the architecture 1 via I/O and I/O lines 16a to 16n. In particular, the ECU 2 may be configured or adapted to manage and regulate the critical functions of the architecture 1 that may be related to, for example, fuel delivery and injection. By receiving electrical inputs from various pressure sensors 8a, 8b, tank level sensors 11b, tank temperature sensors 11a, crank position sensors 16g, the ECU 2 may ensure precise control of the fuel delivered to each engine cycle to achieve optimal performance of the engine 3 and its architecture 1.

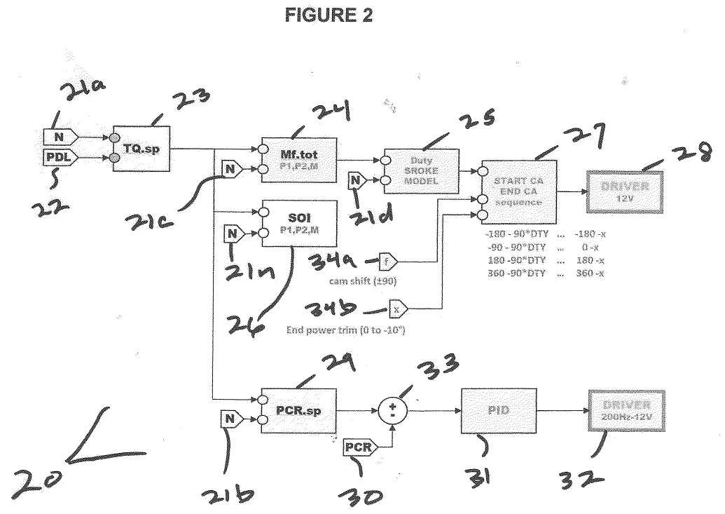

Referring now to FIG. 2 there is shown a representation of an exemplary fuel system control methodology 20 according to one embodiment of the present disclosure.

For the reader's benefit, the following is a reference key to the steps of the methodology 20 shown in FIG. 2. Rather than repeatedly state that the ECU 2 receives and sends electronic signals to elements of architecture 1, for the sake of brevity it should be understood that in the steps set forth in FIG. 2, the inputs or outputs from/to elements of the architecture 1 and the ECU 2 may be exchanged via I/O and I/O lines 16a to 16n.

Inputs “N” (21a to 21n) and pedal position PDL 22 (i.e., pedal position input data, which may be sent from either a throttle pedal or generator controller) received by the ECU 2, where “N” may include the speed of the engine 3. In an embodiment, the ECU 2 may receive inputs N (21a to 21n) and PDL 22 and may be caused to generate a corresponding torque setpoint 23 (TQ.sp) by retrieving and executing instructions from its electronic memory. Further, upon generating a torque setpoint 23 the ECU 2 may further generate a fuel mass total 24 (abbreviated “Mf.tot”) and start of injection (SOI) timing signals 26 based on the generated torque setpoint 23 and other values by retrieving and executing additional instructions from its electronic memory.

For example, the ECU 2 may generate a fuel mass total 24 based on the torque setpoint 23 and an inputs N 21c, where the inputs 21c may comprise values representing parameters such as Inlet fuel pressure (P1), outlet fuel pressure (P2) and fuel mass (M). Upon generating the fuel mass total 24 the ECU 2 may generate a fuel injection duty cycle that controls the timing of the injection of fuel by the one or more fuel injectors 10 by inputting the fuel mass total 24 into a DUTY STROKE MODEL process 25 by retrieving and executing corresponding instructions from its electronic memory.

In an embodiment, the ECU 2 may electronically store the DUTY STROKE MODEL process 25 as electronic instructions in its memory (not shown). Thereafter the ECU 2 may compare inputs it receives from the architecture 1 in order to precisely control one or more features and operations of the engine 3 and its architecture 1, such as fuel injection.

Depending on the parameters and thresholds that are a part of the MODEL process 25 the ECU 2 may generate injection times and time periods and amounts of fuel that may be injected by injectors 10 into combustion chambers of the engine 3 based on inputs it receives from one of the components of the architecture 1 or from stored the MODEL process 25 again, by retrieving and executing instructions from its electronic memory. Such inputs may comprise engine speed and pedal position, for example. By managing the duty cycle of the fuel injectors 10, the ECU 2 can ensure optimal fuel delivery, enhanced combustion efficiency and engine performance.

In an embodiment, the inventive, exemplary Model process 25 may include stored electronic instructions that integrate the Model process 25 with other control units in order to maintain consistent and accurate fuel pressures and fuel delivery which is believed to directly impact the engine's 3 power output, fuel efficiency, and emissions.

In more detail, the ECU 2 may receive both the fuel mass total 24 (Mf.tot) and engine speed (N) 21d. As noted previously, these values may then be electronically generated and processed by the ECU 2 as a part of completing the Duty STROKE MODEL process 25, where the instructions for executing and completing the process 25 may be electronically retrieved by the ECU 2 from its electronic memory. As a result of processing of the fuel mass total 24 (Mf.tot) and engine speed (N) 21d as a part of the MODEL process 25 a fuel injection duty cycle is generated by the ECU 2.

In an embodiment, the so generated fuel injection duty cycle may be used along with two variable values, denoted “f” 34a and “x” 34b in FIG. 2 (and FIG. 3) to control the timing and time duration of the injection of fuel per cycle by the injectors 10. The inventive process for generating and implementing the timing and time periods (i.e., duration) governing the injection of fuel by the injectors 10 may comprise a sequence of actions (i.e., events) that are generated, implemented, and controlled by the ECU 2 based on retrieved and executed instructions from its electronic memory. Such a sequence of events may be referred to as a “START CA END CA sequence” 27.

In more detail, the ECU 2 may generate a “START CA END CA sequence” 27 that may comprise a set of electronic signals representing “start” and “end” crank angles for an injection cycle. The signals may be converted into suitable control signals and sent to an electronic driver 28 (e.g., a 12V electronic component). In an embodiment, the injection, solenoid driver 28 may be configured to output its own set of control signals that are sent to the injectors 10 to control the injection (e.g., to start and stop an injection) of fuel (e.g., a heavy fuel) by the injectors 10 into a combustion chamber of the engine 3.

As noted previously, the ECU 2 may also generate SOI timing signals 26 based on the generated torque setpoint 23 and other N 21n values. Upon receiving the torque setpoint 23 and other N values 21n the ECU 2 may retrieve additional parameters from its memory or another electronic memory for example (e.g., Inlet fuel pressure (P1), outlet fuel pressure (P2) and fuel mass (M)) to generate a SOI value that represents a time that the injectors 10 will begin to start injecting fuel into the combustion chamber. This SOI value may then be used in completing the START CA END CA sequence 27.

As noted previously, two variable values, denoted “f” 34a and “x” 34b and a fuel injection duty cycle may be used to control the timing and duration of the injection of fuel by the injectors 10. In an embodiment the variable value “f” 34a may comprise a value representing a cam shift position while the variable value “x” 34b may comprise an End Power Trim value. In an embodiment, the ECU 2 may retrieve and execute instructions from its electronic memory to use these values to adjust the timing of the injection of fuel by the injectors 10 based on the position of the camshaft and power trim requirements.

As noted previously, the methodology 20 controls both fuel injection and pressure within the elements of the architecture 1.

For example, in an embodiment the ECU 2 may retrieve and execute instructions from its electronic memory to generate a desired pressure control setpoint 29 (PCR.sp) based on the speed of the engine N 21b and the torque setpoint 23 (TQ.sp) and then compare the desired pressure control setpoint to the actual pressure (PCR) 30 measured by one or more of the pressure sensors 7a,7b. Once the comparison of the desired pressure control setpoint to the actual pressure 30 has been completed by the ECU 2, the ECU 2 may retrieve and execute instructions from its electronic memory to adjust the pressure being generated by the pump 4 by sending electronic control signals to a fuel pump, solenoid driver 32 (e.g., 200 Hz, 12V electronic device) which, in turn, sends electronic signals to the pump 4. In an embodiment the ECU 2 may comprise an electronic PID Controller 31 that receives the result (i.e., value) representing the comparison of the Pressure Control Setpoint and actual pressure, and then output one or more electronic signals to adjust the output to the driver 32 in order to control the pressure being generated by the pump 4.

In an embodiment, the ECU 2 may be configured to use the torque setpoint 23 (TQ.sp) to adjust both the timing of the injection of fuel by the injectors 10 into the combustion chamber as well as the pressure being generated by the pump 4 by retrieving and executing corresponding instructions from its electronic memory. In more detail, in an embodiment the ECU 2 may store a calibration look-up table in its electronic memory (not shown). Further, the look-up table may include TQ.sp data and engine speed data that may be used to form and generate a graph. Still further, the ECU 2 may store additional data in a plurality of tables (e.g., 3 tables) that may be used to map, monitor, track and generate control and command signals to control (i) the quantity of fuel total (MF.tot) to be injected, (ii) fuel pressures (PCR) and (iii) injection times and duration for SOI main, pilot, and post injections such that for a given engine load and speed, a fuel injector 10 may receive specific timing and pulse width command and control signals.

The inventors believe that electronically controlling the pressure of the pump 4 by the ECU 2 decreases the mechanical energy needed to pressurize the fuel (when compared to existing engines whose pumps are mechanically controlled) while simultaneously increasing the mechanical efficiency of the pump 4 (i.e., improves the ability of the engine 3 to convert a higher percentage of energy from the fuel into useful work (i.e., Brake Thermal Efficiency).

Referring now to FIG. 3 there is depicted a graph of signals representing the operation of a fuel solenoid inlet valve and its effect on fuel pressure that can be generated by a fuel pump with respect to an engine's crank angle (CA) according to experiments conducted by the inventors.

The horizontal or x-axis represents the crank angle, ranging from −360 to 360 degrees, indicating one full cycle of an experimental engine, such as engine 3. The abbreviation “SOL ON” associated with the darker lines in FIG. 3 indicates those time periods 36a, 36b to 36n (where “n” indicates the last time period) when the solenoid of a fuel inlet valve is activated in order to control the opening and closing of a valve while the words “Valve Open/Close” associated with the lighter lines in FIG. 3 indicates the time periods 35a, 35b, 35c to 35n when a solenoid fuel inlet valve to the pump 4 is actually open. In an embodiment, there is a delay between the solenoid activation and the valve opening due to mechanical response times.

Taken together, the lighter and darker curves in FIG. 3 comprises a duty cycle of the experimental fuel injection system of the architecture 1 described herein, with key points marked at −180, −90, 0, 90, 180, 270, and 360 degrees.

FIG. 3 also includes a dotted line 37 that indicates the variation in fuel pressure as the crank angle changes from −180 degrees to +360 degrees. In embodiments, the inventors discovered that the pressure of the fuel (e.g., a heavy fuel) increases and decreases in response to the activation or deactivation of the solenoid fuel inlet valve.

FIG. 3 also indicates two fuel injection, timing adjustment values. One timing adjustment value is related to the camshaft position f which affects the timing of the injection of fuel by injectors 10. A second timing adjustment value is related to the adjustment of an end power trim x which may modify the end of the time period that governs the injection of fuel by injectors 10 by allowing injection as the crank angle changes by −10 degrees or less, for example.

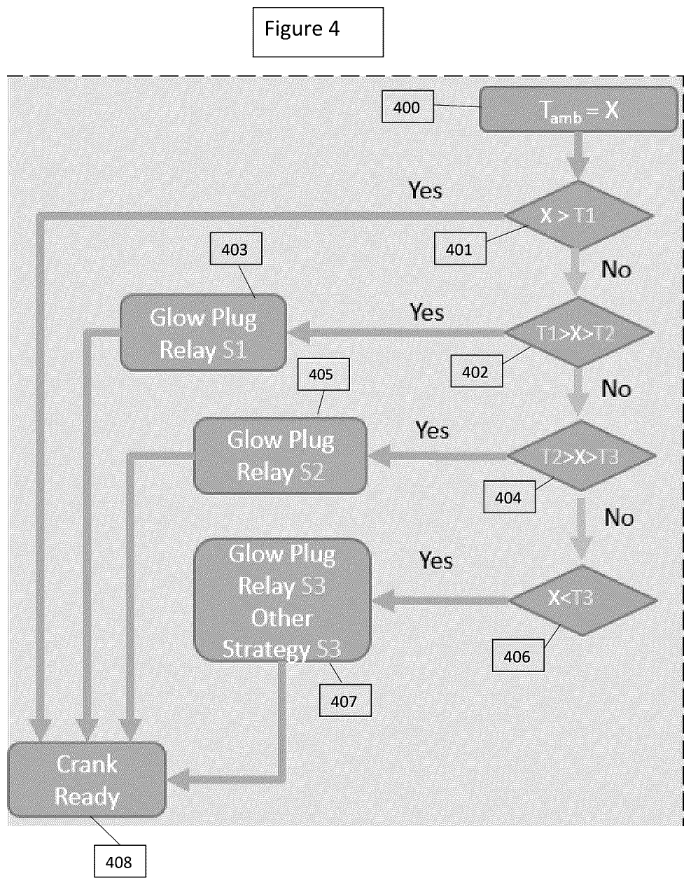

Referring now to FIG. 4 there is depicted an exemplary, simplified control method 400 to 408 for improving the cold start performance of an engine, such as engine 3.

In an embodiment, the engine 3 may include one or more glow plugs (not shown in figures) which use resistive heating and direct current electricity to add energy (heat) to the combustion chamber or pre-combustion chamber. In an embodiment, adding heat may aid the evaporation and autoignition of an injected fuel at low engine temperatures (i.e., so-called “cold start” conditions).

As initial steps the ECU 2 may be configured to receive electrical power and “boot up” (i.e., complete a start-up process). Thereafter the ECU 2 may receive signals representing a temperature (or temperatures) of the engine 3 (from temperature sensors, for example) in step 400.

Thereafter, the ECU 2 may be caused to execute one or more instructions stored in its electronic memory to select a time period during which the glow plug will be turned on to heat the combustion chamber or fuel. For example, if the ECU 2 determines that the detected, ambient temperature of the engine 3 (hereafter “detected temperature”) is at or above a first threshold temperature T₁ in step 401, then the ECU 2 may indicate that the engine is ready to start (“crank ready”) in step 408 and not elect to initiate the use of a glow plug for a given time period because the detected temperature is high enough to start the engine without using a glow plug. If, however, the detected temperature is below a first threshold temperature T₁ in step 401, the ECU 2 may then determine if the detected temperature is between a second threshold temperature T₂ and the first threshold temperature T₁ in step 402. If so, the ECU 2 may send electronic signals to one or more glow plugs to energize the glow plug(s) (i.e. relay) for a first time period S1 in order to heat the combustion chamber or fuel in step 403. The first time period S1 may be stored in the electronic memory of the ECU 2 or be pre-configured by the glow plug to heat the engine to a temperature that allows the engine 3 to be safely started in step 408.

If, however, the detected temperature is below a first threshold temperature T₁ in step 401, and not in between the second threshold temperature T₂ and the first threshold temperature T₁ in step 402, then the ECU 2 determines whether the detected temperature is in between the second threshold temperature T₂ and a third threshold temperature T₃ in step 404. If so, the ECU 2 may send electronic signals to one or more glow plugs to energize the glow plug(s) (i.e., to a relay) in order to heat the combustion chamber or fuel in step 405 for a second time period S2 in order to heat the combustion chamber or fuel in step 403. The second time period S2 may be longer than the first time period S1 and may be stored in the electronic memory of the ECU 2 or be pre-configured by the glow plug to heat the engine to a temperature that allows the engine 3 to be safely started in step 408.

Further, if, however, the detected temperature is below a first threshold temperature T₁ in step 401, and not in between the second threshold temperature T₂ and the first threshold temperature T₁ in step 402, and still not in between the third threshold temperature T₃ and the second threshold temperature T₂ in step 404, then the ECU 2 determines that the detected temperature is below the third threshold temperature T₃ in step 406. If so, the ECU 2 may send electronic signals to one or more glow plugs to energize the glow plug(s) (i.e., to a relay) in order to heat the combustion chamber or fuel in step 407 for a third time period S3 in order to heat the combustion chamber or fuel in step 403. The third time period S3 may be longer than the first and second time periods S1, S2 and may be stored in the electronic memory of the ECU 2 or be pre-configured by the glow plug to heat the engine to a temperature that allows the engine 3 to be safely started in step 408.

In the discussion above it was stated that the ECU 2 sends electronic signals to one or more glow plugs. In slightly more detail, each glow plug may have one or more relays that may receive the signals from the ECU 2 to turn the glow plug on or off (i.e., provide heat or stop heating).

Alternatively, the ECU 2 may send such signals to an additional electrical relay that is connected to an additional starting aid (other than a glow plug), such as a grid heater, fuel heater, fuel vaporizer, coolant heater, block heater, for example, which may allow the ECU 2 to control the starting of the engine 3 at temperatures below those at which a glow plug is effective (i.e., a temperature that is too low) to heat the combustion chamber or fuel of the engine 3.

In the case where a glow plug is used to start the engine 3, the engine 3 may include a glow plug indicator (e.g., a light) that may be controlled by the ECU 2. In an embodiment, the ECU 2 may send electrical signals to the indicator to turn the indicator “on” or “off” to correspond to an associated glow plug being “on” or “off”, for example. Such an indicator allows a user of the engine 3 to realize that a glow plug is in use (or not) to prepare the engine 3 for starting.

Yet further, the engine 3 may also include a “crank ready” indicator (e.g., a light) that may also be controlled by the ECU 2. In an embodiment, the ECU 2 may access instructions from its electronic memory that cause and allow the ECU 2 to track a “cold start” process for the engine 3. Upon completion of a cold start process (or another start-up process) the ECU 2 may generate electrical signals indicating the start-up process has been completed and send such electrical signals to the crank ready indicator to turn the indicator “on”. Such an indication allows a user of the engine 3 to realize that the start-up preparation process has been completed and the user may then turn the engine 3 “on” (i.e., start cranking the engine 3 over).

The exemplary method illustrated by FIG. 4 and described above is only one method that may be used to cold start the engine 3.

As an alternative, the engine 3 may be configured to employ fuel injection timing. In such an embodiment the ECU 2 may send electronic signals to a fuel injector that causes the fuel injector to inject a small amount of heated fuel into the combustion chamber of the engine 3 before a main or primary injection of fuel occurs (i.e., a “pilot” amount; by small or pilot amount is meant an amount of fuel that is substantially less than the amount of fuel typically injected in a main injection).

In such an embodiment, the ECU 2 may be configured to execute instructions from its electronic memory to control the timing of such pilot injections. For example, the ECU may send electronic signals to a fuel injector to inject such a pilot amount in advance (before) of a main injection in order to allow more time for the evaporation of fuel and/or mixing of fuel as part of a cold start process for starting the engine 3.

The claim language that follows below is incorporated herein by reference in expanded form, that is, hierarchically from broadest to narrowest, with each possible combination indicated by the multiple dependent claim references described as a unique standalone embodiment.

While benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

We claim:

1. An electronic control unit (ECU) for monitoring and controlling at least fuel pressures of an engine, the ECU configured to:
generate a desired pressure control setpoint (PCR.sp) based on a speed of the engine and a torque setpoint (TQ.sp);
compare the generated, desired pressure control setpoint to an actual pressure (PCR) measured by one or more pressure sensors; and
adjust a pressure being generated by a fuel pump by sending electronic control signals to a fuel pump, solenoid driver.

2. The ECU as in claim 1 wherein the engine comprises an inwardly opposed piston engine and wherein the engine is configured to operate using both gaseous or liquid fuel.

3. The ECU as in claim 2 wherein the fuel comprises one of diesel, biodiesel, JP-8 or F-24 (NATO equivalent) or Fisher-Tropsch fuels.

4. The ECU as in claim 1 wherein the ECU comprises an electronic PID Controller.

5. The ECU as in claim 1 further comprising (i) the one or more pressure sensors, one or more fuel tank level sensors, one or more tank temperature sensors, one or more crank position sensors, wherein the ECU is further configured to ensure control and optimal performance of the engine and (ii) one or more input/outputs (I/O) and corresponding communication lines for exchanging electronic signals between the ECU and the engine.

6. The ECU as in claim 1 wherein the ECU comprises at least one electronic memory for storing (i) a calibration look-up table that includes setpoint data and engine speed, (ii) data used to generate control and command signals to control (a) a quantity of fuel total to be injected into the engine, (b) fuel pressures (PCR) and (c) injection times and duration for SOI main, pilot, and post injections.

7. The ECU as in claim 6 further comprising generating timing and pulse width command and control signals for a fuel injector based on an engine speed and RPM.

8. An electronic PID Controller configured to:
receive a value representing a comparison of a pressure control setpoint and actual pressure; and
output one or more electronic signals to fuel pump solenoid driver to control a pressure generated by a fuel pump.

9. A method for electronically controlling an engine comprising:
i) receiving Inputs “N” and pedal position input data from a throttle pedal or generator controller at an ECU; ii) generating a torque setpoint from the Inputs N and pedal position input data; iii) generating a fuel mass total and start of injection (SOI) timing signals based on at least the generated torque setpoint.

10. The method as in claim 9 wherein the inputs N comprise engine speed or fuel pressure.

11. The method as in claim 9 wherein the generation of the fuel mass total further comprises generating the fuel mass total based on the torque setpoint and an Inlet fuel pressure (P1), an outlet fuel pressure (P2) and a fuel mass (M).

12. The method as in claim 9 further comprising generating a fuel injection duty cycle by inputting the fuel mass total into a Duty STROKE MODEL process that is stored as electronic instructions in an electronic memory of the engine.

13. The method as in claim 12 further comprising controlling the timing and time duration of fuel injection per cycle by one or more fuel injectors using the generated fuel injection duty cycle and two variable values.

14. The method as in claim 13 wherein one of the two variable values comprises a value representing a camshaft position and the second one of the two variable values comprises an End Power Trim value, wherein the method further comprises adjusting an injection timing based on the two variable values.

15. The method as in claim 9 further comprising generating a desired pressure control setpoint based on a speed of the engine and the torque setpoint and comparing the generated, desired pressure control setpoint to an actual pressure measured by one or more pressure sensors.

16. The method as in claim 15 further comprising adjusting the pressure being generated by a fuel pump by sending electronic control signals to a fuel pump, solenoid driver.

17. A method for generating and implementing fuel injection timing and time periods of an engine comprising: i) generating a sequence of electronic signals representing “start” and “end” crank angles for an injection cycle; ii) sending the generated signals to an electronic injection, solenoid driver configured to output a set of control signals; iii) sending the output control signals to one or more fuel injectors to control the injection time period of fuel by the one or more fuel injectors into a combustion chamber of the engine.

18. The method as in claim 17 wherein the injection time period comprises the time associated with a start of the injection of fuel until a time that the injection of fuel stops.

19. The method as in claim 17 wherein the fuel comprises a heavy fuel.

20. The ECU as in claim 1 wherein the ECU is further configured to:
receive signals representing a temperature of the engine; and
select a time period during which one or more glow plugs are turned on to heat the combustion chamber or fuel of the engine.

21. A method for cold starting an engine comprising:
receiving signals at an ECU representing a temperature of the engine; and
selecting one or more time periods, by the ECU, during which one or more glow plugs are turned on by the ECU to heat the combustion chamber or fuel of the engine.
